(19) United States
(12) Patent Application Publication
(10) Pub. No.: US 2010/0028495 A1
(43) Pub. Date: Feb. 4, 2010

(54) BEVERAGE CARTRIDGE

(76) Inventors: Thomas J. Novak, Morristown, VT (US); Laurence Lee, Owatonna, MN (US)

Correspondence Address: WOLF GREENFIELD & SACKS, P.C., 600 ATLANTIC AVENUE, BOSTON, MA, 02210-2206, US

(21) Appl. No.: 12/400,995

(22) Filed: Mar. 10, 2009

Related U.S. Application Data
(60) Provisional application No. 61/068,811, filed on Mar. 10, 2008.

(51) Int. Cl. B65B 29/02; B65D 83/00; A47J 31/44; A23F 5/00; A23F 3/00; A23L 2/02; A23L 2/52; A23C 11/00; A23C 9/00

(52) U.S. Cl. 426/77; 99/295; 426/425; 426/433; 426/435

(57) ABSTRACT

A beverage cartridge and method for forming a beverage is provided. The cartridge may include a container having an internal volume with a substantially soluble beverage precursor disposed within the container. The beverage precursor may be formed of a plurality of particulates where at least 60% of the plurality of particulates has a largest dimension that is greater than about 200 microns and less than about 700 microns. The cartridge may be water tight, and may be filterless. A liquid can be introduced into the container at a volumetric flow rate of at least 0.03 ounces/second to dissolve the beverage precursor to form a beverage.

### RELATED APPLICATION

This application claims the benefit of U.S. Provisional application 61/068,811, entitled “Systems and Methods for Portion-Packaged Foods and Beverages”, filed Mar. 10, 2008, and is hereby incorporated by reference in its entirety.

### BACKGROUND

1. Field

The present application relates to a beverage cartridge, and methods for using the beverage cartridge with a liquid to make a beverage.

2. Discussion of Related Art

There are a variety of known pre-packaged beverage precursors that produce a beverage with the addition of a liquid, such as water. For example, a tea bag encloses tea leaves within a filter bag. To brew tea, the tea bag is submerged into hot water such that the tea leaf flavors infuse into the water. The filter bag prevents the tea leaves from mixing into the water.

To make coffee, hot water is passed through coffee grounds such that the coffee ground flavors infuse into the water. Like tea leaves, coffee grounds are not highly soluble, so a coffee filter typically separates the coffee grounds from the finished beverage.

Devices exist that automate the process of making a beverage with a beverage precursor, such as ground coffee or tea. For example, a conventional coffee machine heats water that is delivered to a filter holding coffee grinds. The hot water passes through the filter after the coffee flavors have infused into the water, resulting in a coffee beverage. Some beverage machines exist that use a disposable cartridge to form a beverage. With such machines, a user may place a cartridge in the machine, which then introduces water or other liquid into the cartridge that mixes with a beverage precursor, such as ground coffee or tea. A finished beverage may then exit the cartridge and be collected in the user's cup.

### SUMMARY OF INVENTION

Aspects of the invention provide a method and apparatus for forming beverages using a beverage cartridge containing a substantially soluble beverage precursor, such as a particulated hot chocolate mix. In some embodiments, the beverage precursor can include only highly soluble materials, and thus may not include ground coffee, tea or other materials that are not highly soluble. In some embodiments, the cartridge may be filter free, and thus liquid entering the cartridge may travel through the cartridge without passing through a filter of any kind. For example, a cartridge may enclose a particulated hot chocolate mix that is arranged to dissolve when hot water is passed through the cartridge. The cartridge may include a water-tight container with a defined volume that is larger than the volume of the hot chocolate mix or other beverage precursor in the cartridge, e.g., the container volume may be 2 times or more of the volume of the beverage precursor volume. The container (which may include a lid that closes an opening of the container) may be piercable or otherwise have an opening to permit liquid, such as hot water, to be introduced into the cartridge to form a beverage that exits the cartridge, e.g., through another opening in the container. The beverage precursor may include only (or a substantial proportion of) particulates within a specific size range, e.g., 200-700 microns, which the Applicant has found to be important to dissolving of some beverage precursors. In some embodiments, the beverage precursor may include about 60%, 80%, 90%, 95% or more of particulates within the 200-700 micron range. In some cases, particulates of a desired size may be formed by agglomerating a beverage precursor material, and then screening or otherwise sizing the agglomerated particulates.

According to one aspect of the invention, a beverage cartridge is provided that includes a container having an internal volume. The container may have any suitable shape, such as a frustoconic shape with a substantially flat bottom, a sidewall, a rim defining an opening that provides access to the internal volume, and a cover that closes the opening. A substantially soluble beverage precursor is disposed within the container, where the substantially soluble beverage precursor is formed of a plurality of particulates. At least 60% or more of the particulates may have a largest dimension that is between about 200 microns and about 700 microns, or more preferably between about 300 and 600 microns. The beverage container may be closed such that the internal volume of the container is water tight. The internal volume of the container may be greater than the volume of the beverage precursor, and may be arranged such that the liquid can be introduced into the container at a volumetric flow rate of at least about 0.03 ounces/second to dissolve the beverage precursor to form a beverage, which may exit the container by way of an opening or other outlet.

According to another aspect of the invention, a method of preparing a beverage includes providing a beverage cartridge having a container with an internal volume, and a substantially soluble beverage precursor disposed within the container, where the substantially soluble beverage precursor is formed of a plurality of particulates. At least about 60% of the plurality of particulates may have a largest dimension that is greater than about 200 microns and less than about 700 microns, and the container may be closed such that the internal volume of the container is water tight. The method may further include providing a first opening in the container, introducing a liquid into the beverage cartridge through the first opening at a volumetric flow rate of at least 0.03 ounces/second, thereby forming a beverage when the beverage precursor dissolves in the liquid, and providing a second opening in the container, such that the beverage exits the second opening. The providing or forming of the first and/or second openings may involve piercing the container at one or more locations, introducing pressure into the container to cause one or more portions of the container to burst or otherwise form an opening, fluidly connecting to a pre-existing, openable conduit of the container (such as a tube and valve structure), and so on.

According to yet another aspect of the invention, a beverage system is provided that includes a container having a fixed internal volume. The container may have a frustoconic shape with a substantially flat bottom, a sidewall and a rim defining an opening that provides access to the fixed internal volume. The beverage system includes a substantially soluble beverage precursor disposed within the container, where the substantially soluble beverage precursor is formed of a plurality of particulates arranged so that at least about 60% of the plurality of particulates has a largest dimension that is greater than about 200 microns and less than about 700 microns. The system further includes a cover attached to the rim closing the opening of the container such that the fixed internal volume of the container is water tight. The system also includes an inlet configured to provide a first opening to introduce a liquid into the container to form a beverage when the beverage precursor dissolves in the liquid, and an outlet configured to provide a second opening through the container to dispense the beverage from the beverage system. (The first and second openings may include one or more openings or other flowpaths, and the inlet and outlet may sealingly engage with the container or not. For example, a gasketed tube at the inlet may seal with the cover to introduce liquid into the container, while a hole or conduit at the outlet may allow beverage that exits the container to pass to a waiting cup.)

Various embodiments of the present invention provide certain advantages. Not all embodiments of the invention share the same advantages and those that do may not share them under all circumstances.

Further features and advantages of the present invention, as well as the structure of various embodiments that incorporate aspects of the invention are described in detail below with reference to the accompanying drawings.

### BRIEF DESCRIPTION OF THE DRAWINGS

The accompanying drawings are not intended to be drawn to scale. In the drawings, each identical or nearly identical component that is illustrated in various figures is represented by a like descriptor. For purposes of clarity, not every component may be labeled in every drawing.

Various embodiments of the invention will now be described, by way of example, with reference to the accompanying drawings, in which:

FIG. 1 is a front perspective view of a beverage brewer in a closed position;

FIG. 2 is a side view of the beverage brewer illustrated in FIG. 1 in an open position;

FIG. 3 is a schematic cross-sectional illustration of a beverage cartridge according to one embodiment of the present invention;

FIG. 4 is a table illustrating the Reynolds Number for a variety of liquid flow conditions according to different embodiments of the present invention;

FIG. 5 is a schematic illustration of a method of preparing a beverage according to one embodiment of the present invention;

FIG. 6 is a schematic illustration of a system for agglomerating the beverage precursor according to one embodiment of the present invention;

FIG. 7 is a distribution plot for an agglomerated beverage precursor particulates according to one embodiment of the present invention; and

FIG. 8 is a distribution plot for agglomerated beverage precursor particulates according to another embodiment of the present invention.

### DETAILED DESCRIPTION

Aspects of the invention are directed to a beverage cartridge, and methods for making a beverage using a beverage cartridge, with a substantially soluble beverage precursor. As discussed above, there are a variety of known beverage cartridges that use beverage precursors, such as coffee or tea, to produce a beverage with the addition of a liquid. Some aspects of the invention involve the use of only soluble beverage precursors in a beverage cartridge. However, other aspects of the invention may involve the use of beverage precursors that are not highly soluble, such as coffee or tea, as well as soluble beverage precursors. For example, a beverage cartridge in one embodiment may include ground coffee (not highly soluble) as well as a particulated mocha mix that is soluble. Water introduced into the cartridge may interact with the coffee grounds to form a coffee beverage that passes through a filter in the cartridge and then interacts with the mocha mix, which dissolves into the coffee beverage to produce a mocha/coffee beverage.

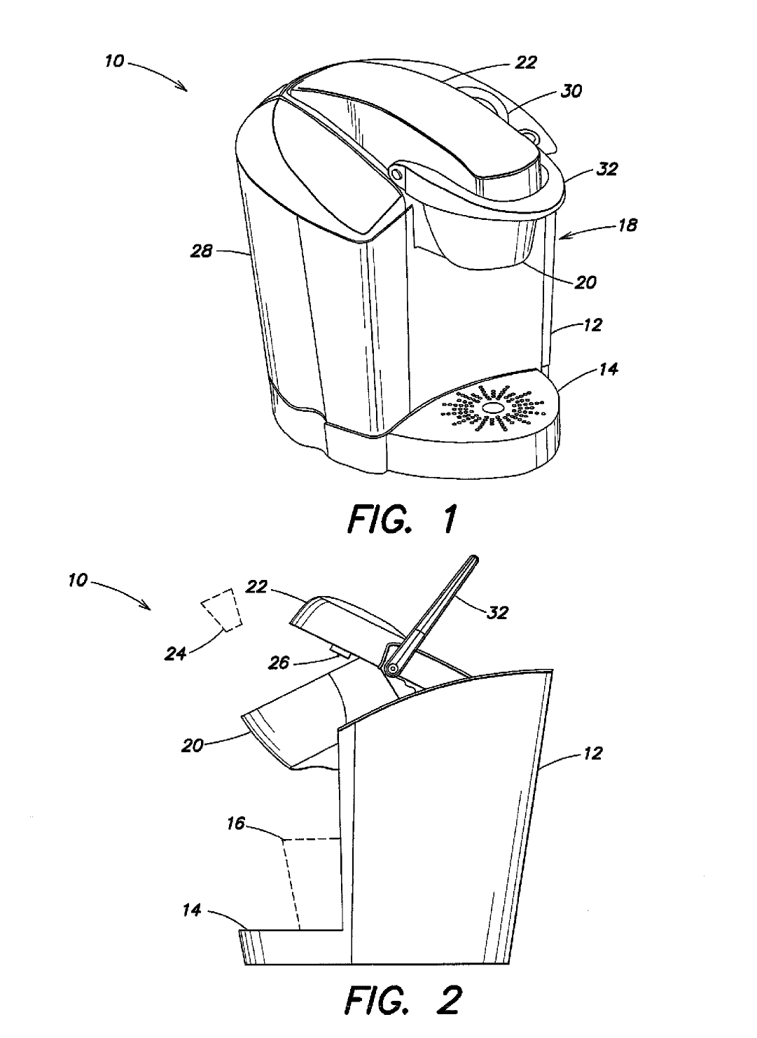

As discussed in greater detail below, Applicant discovered that difficulties arose when developing a beverage cartridge with a substantially soluble beverage precursor. Applicant experimented by placing one type of a substantially soluble beverage precursor, a particulated hot chocolate mix, in a beverage cartridge arranged like that offered under the K-Cup brand by Keurig, Incorporated, i.e., having a frustoconical container closed by a foil/polymer lid. However, unlike many K-Cup brand cartridges, this cartridge did not include a filter, but instead the beverage precursor was simply placed into the cartridge container. The beverage cartridge was sealed by the lid so as to be water tight and placed in a beverage brewer 10, similar to that illustrated in FIGS. 1-2, to form a hot chocolate beverage.

In this illustrative embodiment, the beverage brewer 10 has a housing 12 with a drip tray 14 arranged to support a cup 16. The housing 12 may include components such as a water reservoir 28, a heater, a heating tank, a pump and electronic controls 30 configured to deliver heated water to a brew chamber 18. The brew chamber 18 may include a cartridge receptacle 20 and lid 22. As shown in FIG. 2, the receptacle 20 may move between an open position and a closed position by movement of a handle 32. In the open position, the receptacle may be configured for the insertion and/or removal of a beverage cartridge 24. In this embodiment, the brew chamber 18 includes an inlet needle 26 configured to pierce a first hole through the beverage cartridge for the introduction of water into the cartridge 24, and an outlet needle (not shown) configured to pierce a second hole through the cartridge bottom wall for the beverage to exit the cartridge. When the receptacle is in the closed position (see FIG. 1), water flows into the cartridge 24 through the first hole and a beverage flows out of the cartridge 24 through the second hole and into the cup 16. Water may be forced into the cartridge 24 by a water pump, air pressure or in other ways at a pressure above ambient e.g., 1-5 psi in some embodiments, and in some embodiments may cause the water to flow into the cartridge 24 at a flow rate of about 0.03 ounces/second or more, e.g., at about 0.15 ounces/second. (A flow rate as used herein refers to an average flow of liquid into the cartridge over the course of beverage production. In some cases, liquid may be introduced into the cartridge at a constant rate for a specified time, but in other cases the liquid may be delivered in a sporadic or intermittent fashion. In a case where liquid is intermittently introduced into the cartridge, the flow rate will be determined by dividing the total flow into the cartridge by the total time elapsed between first liquid delivery until beverage production is complete.)

The results of this experiment indicated that the hot water introduced into the beverage cartridge did not effectively dissolve the beverage precursor. This is undesirable for many reasons. First, because in some cases a large amount of the beverage precursor did not dissolve, the resulting beverage was very weak (i.e., the flavors of the beverage precursor were diluted). The undissolved beverage precursor may remain within the beverage cartridge, and because beverage cartridges are typically configured for a single use, any material remaining in the cartridge is wasted material. Also, it is contemplated that the undissolved beverage precursor in the cartridge may potentially block fluid flow from the cartridge and/or through the beverage brewer 10. This may cause the pressure within the brewer 10 to rise which may either damage the brewer 10 and/or if the brewer 10 is equipped with a back-pressure sensor, may cause the brewer to shut off. Lastly, in other cases, incompletely dissolved material exited the cartridge, and so the resulting beverage included larger clumps of the undissolved beverage precursor which made the resulting beverage unpleasing and/or inedible. In view of these problems, Applicant determined that a need exists for a beverage cartridge having a substantially soluble beverage precursor that is configured to substantially dissolve when a liquid is introduced into the cartridge to form a beverage.

As set forth in greater detail below, Applicant discovered that a beverage cartridge that has a beverage precursor with a higher bulk density may be less likely to dissolve in the beverage cartridge than the same beverage precursor having a lower bulk density. Accordingly, in one aspect of the invention, a substantially soluble beverage precursor, such as a particulated hot chocolate, may be provided in a beverage cartridge so as to have a reduced bulk density as compared to a standard form of the beverage precursor, e.g., particulated hot chocolate that might be found in packages or cans. Moreover, the beverage precursor may be arranged to maintain a relatively low bulk density even after the cartridge is subjected to physical disturbances, such as those commonly experienced in shipping.

That is, beverage cartridges are typically subjected to movement and vibrations after the beverage precursor has been placed within the cartridge and the cartridge is ready for use. For example, the beverage precursor may be placed within a cartridge at a manufacturing location and the cartridge may thereafter be transported to distribution centers and retail locations. Movement and vibrations may cause the beverage precursor to settle within the cartridge which may make the mixture more compact, thus increasing its bulk density. Because it is inevitable that the beverage precursor will settle in the cartridge, aspects of the invention are directed to a beverage cartridge with a beverage precursor that dissolves within the cartridge even in circumstances where the beverage precursor has a higher bulk density after manufacture, and/or directed to a beverage precursor that tends to maintain a relatively low bulk density.

Applicant also discovered that the size of the particulates forming the beverage precursor may be important to whether the beverage precursor dissolves within the beverage cartridge. In particular, Applicant discovered that for one specific recipe embodiment that when the beverage precursor is formed of particulates that have a largest dimension greater than about 700 microns, the particulates are less likely to dissolve within the beverage cartridge. It is contemplated that particulates that are greater than about 700 microns may be too large to be capable of dissolving under the liquid flow conditions within some cartridges and/or brewing environments.

Furthermore, Applicant discovered that when the beverage precursor is formed of particulates that have a largest dimension that is less than about 200 microns, some of the particulates are less likely to dissolve within the beverage cartridge. It is contemplated that with particulates that are less than about 200-300 microns, some of the particulates may dissolve more quickly, forming a highly viscous solution. This viscous solution may form a barrier between the remaining undissolved beverage precursor and the liquid which may prevent at least some of the beverage precursor from dissolving. Thus, in accordance with another aspect of the invention, a beverage cartridge may include a soluble beverage precursor that has only, or at least a substantial portion of, particulates of a size between about 200-700 microns. In some embodiments, 60%, 80%, 90%, 95% or more of the particulates may have a size between about 200-700 microns, and in some embodiments between about 300-600 microns. Applicant has also determined that particle size may be varied depending on the solubility of the materials in the beverage precursor and/or the way in which the particles are made (e.g., particles having a slow dissolving outer coat may generally call for a smaller particle size).

Turning to the drawings, it should be appreciated that the drawings illustrate various components and features which may be incorporated into various embodiments that incorporate aspects of the invention. For simplification, some of the drawings may illustrate more than one optional feature or component. However, aspects of the invention are not limited to the specific embodiments disclosed. It should be recognized that aspects of the invention encompass embodiments which may include only a portion of the components illustrated in any one figure, and/or may also encompass embodiments combining components illustrated in multiple different drawings.

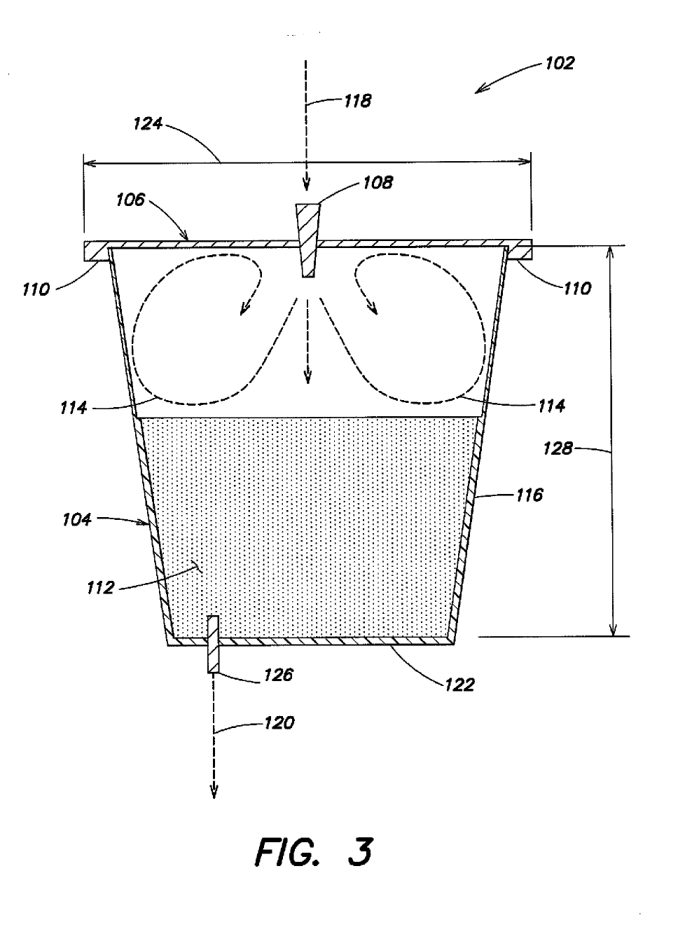

FIG. 3 illustrates one embodiment of a beverage cartridge 102. Generally speaking, aspects of the invention may be employed with a cartridge of any suitable size, shape, configuration or other arrangement. Thus, the illustrative embodiment of FIG. 3 is shown for illustration only. The cartridge 102 of FIG. 3 includes a container 104 having a fixed internal volume. (By having a fixed internal volume, it is meant that the container 104 is generally rigid, semi-rigid or at least tends to maintain a specific shape when not subjected to an external deforming force so as to define an internal volume. However, in some embodiments, the cartridge container may be formed by a material or other arrangement in which the container does not have a defined shape, as is the case with some sachets or pods, and thus does not necessarily have a fixed internal volume.) As illustrated, the container 104 may have an overall frustoconical shape with a bottom 122 and a sidewall 116. In one embodiment, a rim 110 defines an opening that provides access into the fixed internal volume of the container 104. The rim 110 may be positioned at an end of the sidewall 116 opposite the bottom 122. In one embodiment, the container includes a cover 106 that closes the opening such that the internal volume of the container is water tight. In one embodiment, the cover 106 is attached to the rim 110.

A substantially soluble beverage precursor 112 is disposed within the container 104. That is, all or nearly all of the precursor 112 may be soluble and/or suspendable in a suitable liquid, such as water, leaving little or no insoluble materials. One example is a particulated hot chocolate material. As is known, particulated hot chocolate material includes some insoluble materials, such as small fragments of cocoa bean skins, but overall, the particulated hot chocolate material is substantially soluble, and thus “soluble” as used herein. The beverage precursor is not, however, limited to hot chocolate, and may be formed of a variety of materials which are discussed in greater detail below. The beverage precursor may be formed of a plurality of particulates, and in one embodiment, at least 60% of the plurality of particulates have a largest dimension that is greater than about 200 microns and less than about 700 microns. As discussed above, results indicate that this range in particulate size will dissolve when a liquid enters the beverage cartridge 102 under certain flow conditions. As will be understood, particle solubility rates may affect the size range of the particles used in the beverage precursor. For example, a faster dissolving material may permit and/or require the use of generally larger sized particles, whereas a slower dissolving material may permit and/or require the use of generally smaller sized particles.

The beverage cartridge 102 may be arranged to allow liquid to be introduced into the interior volume, e.g., may be pierceable or otherwise have one or more openings in a first location to form a defined inlet for a liquid 118 to enter the container 104. As shown in FIG. 3, in one embodiment, an inlet needle 108 may pierce through the cover 106 to form the inlet. Of course, other arrangements may be used to introduce liquid into the cartridge 102, e.g., one or more knives, blades, tubes or other piercing elements may be used to form one or more openings in the cartridge, the cartridge may have a conduit into which liquid may be introduced, one or more portions of the cartridge may open upon the introduction of water pressure or other force, and so on. Furthermore, the beverage cartridge 102 may be arranged to allow beverage to exit the cartridge 102, e.g., may be pierceable or otherwise have one or more openings in a second location to form a defined outlet for a beverage 120 to exit the container 104. As shown in FIG. 3, in one embodiment, an outlet needle 126 is configured to pierce through the bottom 122 of the container to form the outlet. As with the inlet, other arrangements may be used to permit a beverage to exit the cartridge, e.g., one or more blades, knives, tubes, etc. may form one or more openings in the cartridge, the cartridge may have one or more sections that open upon suitable pressure being present in the interior volume, and so on. The inlet and outlet needles 108, 126 may be components on a device, such as a beverage brewer 110. It should be appreciated that in another embodiment, the beverage cartridge 102 may be pierced differently and/or in other locations on the cartridge, as the invention is not limited in this respect.

As shown in FIG. 3, the internal volume of the container 104 may be greater than the volume of the beverage precursor 112 such that a liquid 118 can be introduced into the container 104 to dissolve the beverage precursor 112 to form a beverage. The liquid 118 may enter the internal volume of the container 104 as a stream or spray 114 or other form. As illustrated, the liquid may swirl around the container 104 to effectively combine with the beverage precursor 112 such that the beverage precursor 112 dissolves in the liquid to form a beverage 120. As discussed in greater detail below, the liquid flow may be turbulent. Moreover, the internal volume of the cartridge may change with the introduction of liquid. For example, if the cartridge includes one or more flexible portions, e.g., like a sachet, the cartridge may expand to increase the interior volume when water under pressure is introduced into the cartridge. This may aid the dissolving process of the beverage precursor, e.g., by increasing a volume for mixing to occur.

The size and shape of the beverage cartridge 102 may vary according to different embodiments of the present invention. In one embodiment, the container 104 has a frustoconic shape with a substantially flat bottom 122. In another embodiment, the container 104 may have a disc shape, and in another embodiment, the container may have a rectangular shape. However, it should be appreciated that in other embodiments, the shape of the container 104 may differ as the invention is not so limited. For example, it is contemplated that the container 104 may have a circular, square, oval, rectangular, or irregularly shaped cross-sectional area. In other embodiments, the beverage cartridge may not have a defined shape, e.g., may be made of a soft-sided bag-like structure and the internal volume of the structure may vary. In one embodiment, the beverage cartridge may be made of a pod-like structure and may be configured similar to a tea bag.

The beverage cartridge 102 may be formed of a variety of materials as the invention is not so limited. In one embodiment, the container 104 is formed of at least one of styrene, ethylene vinyl alcohol (EVOH), and polyethylene. The container may be formed as a composite laminate of these three materials. The outer portion of the container may be formed of styrene and may help to provide a majority of the structure and mass of the container. The styrene may also provide moisture ingress resistance. The EVOH layer may provide oxygen transmission resistance to protect the contents of the cartridge from oxygen ingress from the surrounding atmosphere when the container is sealed with the cover 106. The polyethylene may be an inner laminate layer of the container which contacts the beverage precursor 112 and provides moisture ingress resistance and may help to secure the cover to the container. In one embodiment, the container weighs approximately 2.8 grams.

In one embodiment, the beverage cartridge does not include a filter. For example, the cartridge may be arranged to have a single interior space in which the beverage precursor is located. However, in other embodiments, the cartridge may include a filter, and the filter may be arranged so that a beverage passes through the filter before exiting the cartridge. In another embodiment, the beverage cartridge does not include a filter positioned downstream of the beverage precursor. Thus, in some embodiments, the cartridge may include a filter, but the filter may be arranged so that beverage including soluble beverage precursor does not pass through the filter. For example, a cartridge may have two interior spaces, one space upstream of a filter that includes a beverage precursor, such as ground coffee, and a second space downstream of the filter that includes a soluble beverage precursor, such as a particulate mocha mix. A coffee beverage that is created by water interacting with the ground coffee and passing through the filter to the second space may dissolve the mocha mix to create a final beverage that exits the cartridge.

The cover 106 may be made of a variety of materials as well, and in some embodiments may not be used. In one embodiment the cover is made of an aluminum foil-polyethylene laminate. The aluminum may provide strength and moisture and oxygen ingress resistance. The cover 106 may be heat sealed to the container 102. In other embodiments, the container may be joined to itself to form a closed interior volume, e.g., as is the case with some sachets or pods.

In one embodiment, the internal volume of the container 104 is at least 30 ml. In another embodiment, the internal volume of the container is at least 50 ml. In one particular embodiment, the volume of the container is approximately 2 ounces (˜54 ml). In one embodiment, where the container has a frustoconic shape, the height 128 of the container is approximately 42 mm, the diameter of the substantially circular-shaped bottom 122 is approximately 34 mm, and the diameter 124 of the opening at the top of the container is approximately 50 mm. It should be appreciated that the size and shape of the beverage cartridge 102 may be designed to mate with a brew chamber 18 in a device, such as a beverage brewer 10. For example, in one embodiment, the beverage cartridge is configured to fit into the cartridge receptacle 20 illustrated in FIGS. 1-2.

In one embodiment, the liquid enters into the container as a turbulent flow, and the beverage precursor may be configured to dissolve in the turbulent flow. It is also contemplated that the liquid enters the container as a laminar flow, and in one embodiment, the beverage precursor is configured to dissolve in a laminar flow.

The liquid flow rate into the container may vary, but in one embodiment, the liquid is introduced into the container at a volumetric flow rate of at least 0.03 ounces/second. This is equivalent to filling a 4 ounce cup (see 16 in FIG. 2) in about 120 seconds. As set forth in more detail below, in one embodiment, the liquid may be introduced into the container at a higher volumetric rate, such as at least 0.26 ounces/second, which would fill an 8 ounce cup in about 30 seconds, and in yet another embodiment, the liquid is introduced into the container at a volumetric rate of at least 0.4 ounces/second, which would fill an 8 ounce cup in about 20 seconds. Cartridges may be used to form any suitably sized beverage, such as from 4-12 ounces.

If used, the size of the inlet and outlet openings provided in the beverage cartridge may vary. In one embodiment, the defined inlet is larger than the defined outlet. In one embodiment, the defined inlet is created with an inlet needle 108 that has a diameter of at least 0.09375 inches ( 3/32 inch). In another embodiment, the inlet needle 108 has a diameter of at least 0.1875 inches ( 3/16 inch) and in another embodiment, the inlet needle has a diameter of at least 0.25 inches. The outlet needle 126 may have a diameter of at least 0.125 inches (⅛ inch), and in another embodiment, the outlet needle 126 may have a diameter of at least 0.0625 ( 1/16 inch). In one embodiment, one or both of the needles 108, 126 may have a substantially cylindrical or conical shape, and in another embodiment, one or both of the needles may have a frustoconic shape.

It should be appreciated that the size of the inlet may alter the flow characteristics of the liquid entering the cartridge 102. The Reynolds Number is a non-dimensional parameter defined by the ratio of the dynamic pressure and the shearing stress which can be used to determine whether or not a flow is laminar or turbulent. When a liquid flows through a pipe or duct (which may be analogous to liquid flow into the cartridge 102), the following equation is used to determine the Reynolds Number for the flow of liquid:

$$Re = \frac{( velocity ) ( hydraulic diameter )}{kinematic viscosity}$$

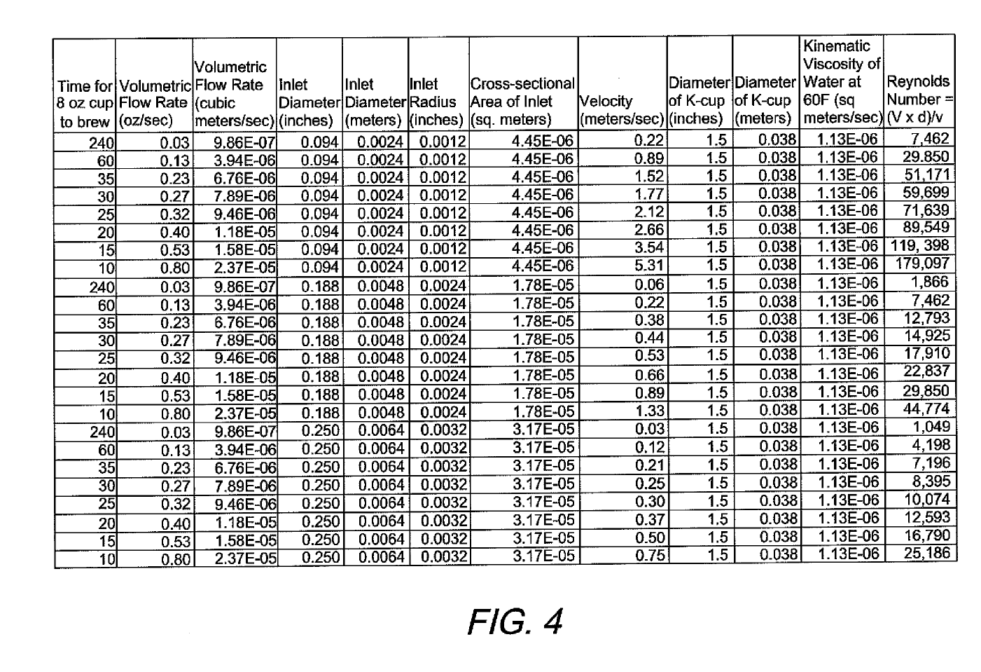

If Re<2300 then the flow is considered to be laminar. If 2300<Re<4000 then the flow is considered to be in a transient stage and if Re>4000 then the flow is considered to be turbulent. The table in FIG. 4 approximates the Reynolds Number under a variety of different flow and inlet configurations. In particular, the volumetric flow rate into the beverage cartridge may vary between 0.03 ounces/second-0.8 ounces/second. The diameter of the inlet also varies between 0.09375 inches-0.25 inches. It should be appreciated that if the volumetric flow rate remains constant, that an increase in the diameter of the inlet will decrease the velocity of the liquid spray into the container. As illustrated in the table, the diameter of the container has been approximated at 1.5 inches and the kinematic viscosity of the liquid has been approximated as water at about 60° F. It should be appreciated that the type of liquid and temperature of the liquid will affect the kinematic viscosity value.

In one embodiment, the beverage cartridge 102 is configured to receive a turbulent flow of liquid having a Reynolds Number of at least 4000. In another embodiment, the cartridge is configured to receive a turbulent flow of liquid having a Reynolds Number of at least 8000, and in yet another embodiment, the cartridge is configured to receive a turbulent flow of liquid having a Reynolds Number of at least 12,000. In one embodiment, the beverage cartridge is configured to receive a flow of liquid having a Reynolds Number of at least 1000, or at least 1500.

The soluble beverage precursor may be formed of a variety of materials, as the invention is not limited in this respect. As mentioned above, in one embodiment, the beverage precursor includes hot chocolate mix. In other embodiments, the beverage precursor may be used to form coffee, espresso, tea (including fruit tea), hot cocoa, cappuccino, café latte, café au lait, café mocha, mocha, cider, juices, various flavored drinks and dairy beverages. Furthermore, it should be appreciated that the beverage precursor may also be used to form various soups, such as, but not limited to tomato soup and various broths, such as chicken broth. One of ordinary skill in the art would appreciate the types of specific materials that may be in the beverage precursor. Some examples of such materials include, but are not limited to, cocoa, chocolate, tea, milk powder, non-dairy creamer, juice extract, espresso, coffee powder, sugar, lactose, sucrose, sucralose, stevia, flow aids, emulsifiers, monoglycerides, diglycerides, and lecithin.

As mentioned above, Applicant recognized that the size of the particulates forming the beverage precursor may be important to whether the beverage precursor dissolves within the beverage cartridge. Applicant discovered that the beverage precursor suitably dissolves as the liquid passes through the cartridge when at least 60% of the particulates have a largest dimension that is greater than about 200 or 300 microns and less than about 600 or 700 microns. In another embodiment, the beverage precursor is formed of a mixture where at least 80% of the particulates have a largest dimension that is greater than about 200 or 300 microns and less than about 600 or 700 microns. In yet another embodiment, the beverage precursor is formed of a mixture where at least 90% of the particulates have a largest dimension between about 200 or 300 microns and 600 or 700 microns, and in a further embodiment, the beverage precursor is formed of a mixture where at least 95% of the particulates have a largest dimension that is between about 200 or 300 microns and 600 or 700 microns.

In one embodiment, the beverage precursor 112 is configured such that all of the particulates have a largest dimension that is less than about 600 or 700 microns. It should be appreciated that in one embodiment, it is desirable for all of the particulates to have a largest dimension that is less than the diameter of the defined outlet. This may help prevent the beverage precursor from clogging the cartridge 102.

It may be desirable to minimize the amount of particulates in the beverage precursor that have a largest dimension that is less than 200 or 300 microns. Thus, in one embodiment, the beverage precursor is configured such that all of the particulates have a largest dimension that is greater than about 200 or 300 microns. However, as a cartridge is transported and as the contents of the cartridge settle, some of the particulates may break down into smaller particulates. Thus, according to one embodiment, the beverage precursor may include some particulates that are less than 200 or 300 microns, but this may make up only a small portion of the beverage precursor. In one embodiment, the amount of particulates that are less than about 200 or 300 microns is 20% or less. In another embodiment, the amount of particulates that are less than about 200 or 300 microns is 15% or less. In yet another embodiment, the amount of particulates that are less than about 200 or 300 microns is 10% or less, and in yet another embodiment, the amount of particulates that are less than about 200 or 300 microns is 5% or less.

There are a variety of ways in which the beverage precursor may be configured to fall within the desired range of particulate size. According to one embodiment, the soluble beverage precursor is agglomerated to achieve this desired particulate size range. In other words, the particulates that form the beverage precursor may be clumped or clustered together to form larger particulates. This is one approach to minimizing the number of particulates that are less than about 200-300 microns. It should be appreciated that particulates that are larger than 600-700 microns may be broken down to fall within the design range of particulate size. An agglomerator is a device used to aggregate particulates into larger aggregate particulates. A more detailed discussion of agglomerators and the agglomeration process may be found at “Encapsulated and Powdered Foods”, edited by Charles Onwulata, published in 2005 by CRC Press, Taylor and Francis Group, 6000 Broken Sound Parkway NW, Suite 300, Boca Raton, Fla. 33487-27542, Library of US Congress Card Number 2004065512, pp. 8, 33, 40, 51-58, 66, and 123-130.

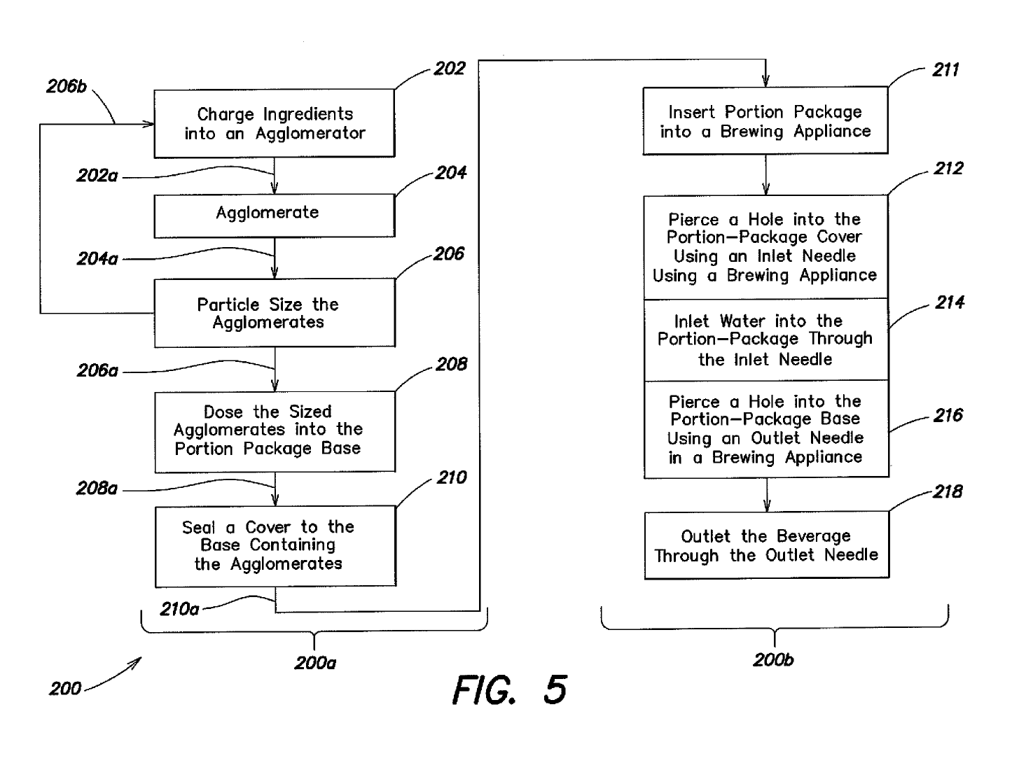

FIG. 5 illustrates a method 200 of preparing a beverage according to one embodiment of the present invention. This method 200 may be broken down into a first sub-method 200a of preparing the beverage precursor and a second sub-method 200b of preparing a beverage with a beverage cartridge.

As illustrated in FIG. 5, sub-method 200a may begin with charging the ingredients 202a that will form the beverage precursor into an agglomerator. In step 204, the beverage precursor is agglomerated. The size of the agglomerated material 204a may then be determined at step 206. There are a variety of known separation and sizing techniques, such as, but not limited to screening, cycloning, and air classifying, which may be used to size the agglomerated material 204a.

As discussed above, Applicant determined that the size of the particulates forming the beverage precursor may be important to whether the beverage precursor dissolves within the beverage cartridge. Thus, in one embodiment, a maximum particulate size, such as about 600-700 microns, may be selected and a screen having a desired mesh may be used to separate out the particulates that have a size larger than the maximum. In one embodiment, these larger particulates may be subjected to mechanical forces to reduce their size. A minimum particulate size, such as about 200-300 microns, may be selected and a screen having a desired mesh size may be used to separate out the particulates that have a size smaller than the minimum. The particulates that are smaller than the minimum size (also known as fines 206b) may be recycled back into the agglomerator for further agglomeration to increase their size.

At step 208, the sized agglomerates 206a may be dosed into a beverage cartridge container 104. In one embodiment, each cartridge is configured for a single serving. In one embodiment, the beverage precursor is formed of approximately 15 grams of the sized agglomerates 206a (although in some embodiments about 5-50 grams of beverage precursor may be charged into the cartridge). At step 210, a cover 106 is attached to the container 104. The cover may be sealed to the container 104 such that internal volume of the container is water tight. The resulting beverage container 210a is ready to be used to create a beverage. In one embodiment, the container 210a is configured for use with a beverage brewer 10, such as the one illustrated in FIGS. 1-2. It should be appreciated that in another embodiment, the cartridge and beverage precursor may be configured for a larger serving, as the invention is not so limited.

Sub-method 200b may begin with the step 211 of inserting the beverage cartridge into a beverage brewer. It should be appreciated that the order of the following steps may be altered as the invention is not limited to a particular order. A first opening is provided in the cartridge in step 212, a second opening is provided in the cartridge in step 216, and a liquid, such as water, is dispensed into the cartridge through the first opening in step 214. In one embodiment, the first opening is formed before the second opening. In another embodiment, the first and second openings may be formed substantially simultaneously. In one embodiment, the second opening is formed at the same time as, or after, the water begins to flow into the cartridge. As mentioned above, inlet and outlet needles may be used to pierce holes through the cartridge. In one embodiment, the first opening is pierced through the cover and the second opening is pierced through the container of the beverage cartridge. In step 218, the resulting beverage exits the cartridge through the outlet needle.

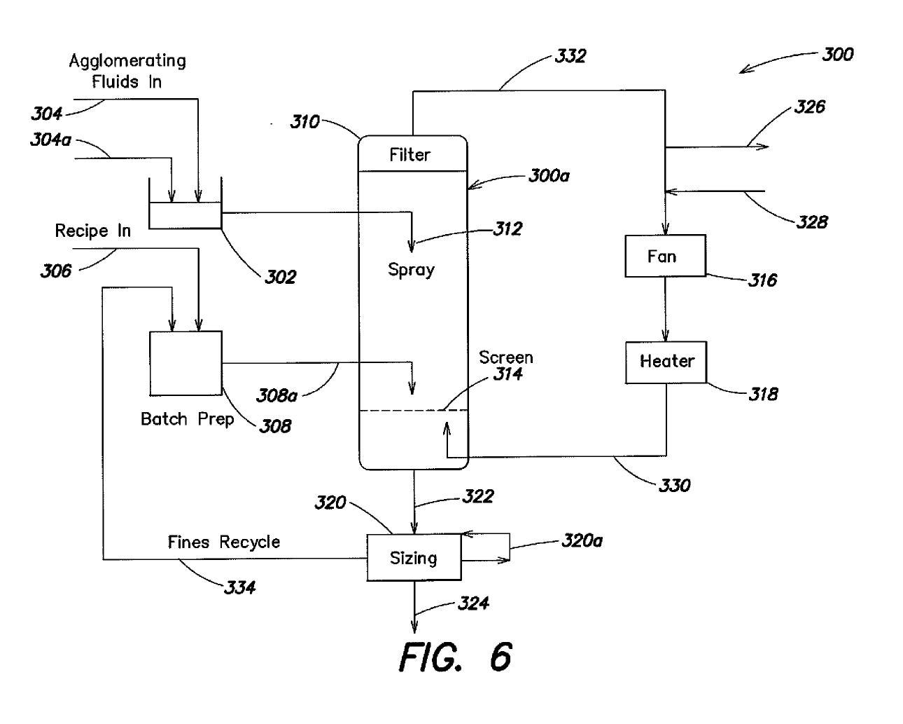

FIG. 6 illustrates a system 300 for agglomerating the beverage precursor according to one embodiment. The beverage precursor 306 may be placed in a holding bin 308 and then charged into the agglomerator 300a. The beverage precursor may be placed on a screen 314 in the agglomerator. Warm air may be generated with a heater 318 and may be forced into the agglomerator with the fan 316. The fan and heater may recycle air into and out of the agglomerator 300a, utilizing the agglomerator air discharge 332 and the agglomerator inlet stream 330. The air discharge 332 can be filtered using filter 310 before being discharged from the agglomerator. Recycled air may be purged via air flow stream 326 and fresh air may be brought into the flow stream via air flow stream 328.

To begin the agglomeration cycle, the warm air stream 330 is initiated to fluidize the beverage precursor 308a. The flow rate of the stream 330 may be adjusted to so that a majority of the beverage precursor particulates reach a height sufficient for spray 312 to contact and wet the particulates. In one embodiment, once fluidization is initiated, a pre-mixing period may occur in which the materials are sufficiently mixed prior to initiation of spray 312 such that a well-mixed mixture is available for agglomeration to begin. Agglomerating fluids 304 may be sprayed onto the fluidized materials from container 302 through spray 312 into the internal cavity of the agglomerator. One of ordinary skill in the art of agglomeration may readily appreciate the various embodiments of agglomerating fluids, their amounts, spray nozzles, and application techniques that may be applied.

In one embodiment, after the agglomerating fluids are used to achieve the desired degree of agglomeration, a second fluid 304a may be applied through spray 312 to further condition the agglomerated particulates. The conditioning may enhance wetting and may provide further control on the solubility rate of the agglomerated particulates. At the end of the agglomeration and spraying cycle(s), finished agglomerated beverage precursor particulates 322 may be discharged from agglomerator 300a and may be sized in sizing stage 320. Fines (e.g. under-sized particulates) may be recycled through agglomeration as stream 334. In one embodiment, over-sized agglomerate particulates 320a may remain within the sizing stage 320 and may be subjected to a size attrition action, for example, by mechanical action. The finished sized agglomerated beverage precursor 324 is then ready for dosing into the beverage cartridge. One of ordinary skill in the art of agglomeration may readily appreciate the various kinds of agglomerators and agglomeration processes that can be employed in the present innovations.

### EXAMPLES

The following examples are illustrative only and are not intended to limit the scope of the present invention.

### Example 1

An unagglomerated dry mix of hot cocoa beverage mix was made by combining together fructose, coconut oil, inulin, alkalized cocoa, sodium caseinate (from milk), maltodextrin, salt, mono and diglycerides, dipotassium phosphate, sodium silico aluminate, soy lecithin, natural and artificial flavors, carrageenan, and acesulfame potassium. Approximately 15 grams of the cocoa mix was placed into a plastic container of about 2 fluid ounces in volume (54 milliliters), as previously described and as illustrated in FIG. 3. This hot cocoa beverage was not agglomerated and/or sized. The container was heat-sealed with a laminate aluminum foil lid, as described above and as illustrated in FIG. 3. The container was then tapped on a hard surface one hundred times by dropping the container from a height of about one inch onto a hard surface such that the container landed squarely on its bottom surface, such as flat circular face 122. A visual inspection of the level of the beverage precursor powder through the semi-translucent side wall of the container showed that the powder in the container had settled and thus compacted due to the tapping action. Another container and beverage precursor mix was prepared but was not subjected to the tapping. Both containers were then brewed in a Keurig, Incorporated brewer model B2003 using 8 ounces (227 milliliters) of hot water (about 90 degrees Celsius) run through the portion package over about a 30 second period at a constant flow rate. The untapped container brewed adequately with the cocoa mix in the container essentially evacuated from the container by the action of the hot brewing water entering and discharging from the container during the brew cycle. The tapped cup, however, did not fully evacuate as a result of the action of the hot water entering and discharging from the container. About 8.1 grams of a wet sludge (made of water and thick wet cocoa mix) remained in the cup. This example shows that vibratory and/or other kinds of movements of a beverage precursor within a beverage cartridge may cause incomplete evacuation of the beverage precursor using a beverage brewer to prepare the beverage.

### Example 2

Another experiment was performed in which hot cocoa beverage mix of the same lot (and thus the same ingredients and proportions) as above was agglomerated using a fluid bed agglomerator as previously described for FIG. 6. The agglomerator was a pilot model fluidized bed agglomerator (Model FL-3 Fluid Bed Granulator) manufactured by Harbin Nano Pharmaceutical and Chemical Equipment Company, Ltd., located at No. 58 Dianlan Street, Nangang, Dist Harbin, China.

Approximately 5 kilograms of the hot cocoa beverage mix was charged into the agglomerator. The fluidization and agglomeration was performed with warm air at 40 degrees Celsius. One liter of a 20 weight % aqueous solution of gum arabic was sprayed onto the top of the fluidized bed of powder, i.e. the spray was directed downward into the fluidized bed of powder. An air-assisted atomization nozzle was used to provide the spray. The spray was conducted at 30 milliliters per minute until the liter of gum arabic solution was completely sprayed. A second spray of 125 milliliters of a 20 weight % aqueous solution of soy lecithin was then sprayed through the same nozzle at 30 milliliters per minute until the 125 milliliters were completely applied. The gum application lasted about 30 minutes and the lecithin application lasted about 5 minutes. The lecithin solution may reduce the tendency of food or beverage materials to solubilize. After the lecithin application, a 2 minute finish drying period was applied. The agglomerator was then turned-off and the agglomerates were discharged. The finished agglomerated beverage precursor had a moisture level of 1.93%.

The loose density of the agglomerated cocoa mix was 0.530 grams/cm³ and its tapped density was 0.583 grams/cm³. Loose density was measured by pouring a weighed quantity of the mix through a funnel into a graduated cylinder and reading the volume on the graduations. To obtain the tapped density, the graduated cylinder containing the mix from the loose density measurement was tapped one hundred times by hand, and then the settled “tapped” volume was read.

The agglomerated cocoa mix was then screened through a U.S. 30 mesh screen (595 micron opening). The “through 30 mesh” fraction (“−30 mesh fraction”) of the agglomerated cocoa mix was then portioned into three portions. A first portion was then screened through a U.S. 40 mesh screen (425 micron opening), a second portion was then screened through a U.S. 50 mesh (300 micron opening), and a third portion was screened through a U.S. 100 mesh screen (150 micron opening). Loose and tapped densities were measured.

The “Hausner Ratio” was also calculated. For background on the applicability of the Hausner Ratio to powder processing and flowability and ease of fluidization of powders, see “Comparison of the Compaction Characteristics of Selected Food Powders by Vibration, Tapping and Mechanical Compression” by J. Malave, G. V. Barbosa-Canovas, and M. Peleg, in the Journal of Food Science Volume 50 (1985) at pp. 1473-1476. See also “Flow Properties of Encapsulated Milkfat Powders as Affected by Flow Agent” by C. I. Onwulata, R. P. Konstance, and V. H. Holsinger, in the Journal of Food Science Volume 61, No 6, 1996 at pp. 1211-1215. See also “Food Powders: Physical Properties, Processing, and Functionality” by Gustavo V. Barbosa-Cánovas, Ortega-Rivas, E., Juliano, P., and Yan, H, published by Springer, 2005, XVI, ISBN: 978-0-306-47806-2.

In general, as the Hausner Ratio increases, the flowability and ease of fluidization decreases. Approximately 15 grams of each of the screened portions and the unscreened original agglomerated mix was placed into beverage cartridges, as described above, then tapped 100 times to settle the contents as was done in Example 1, and then brewed in a Keurig brewing appliance (same as Example 1) with 8 ounces (227 milliliters) of a hot water flow stream (at approximately 90 degrees Celsius) over about a 30 second brewing period at a constant flow rate. The four brewed cartridges were opened-up by peeling away the aluminum foil laminate cover, for visual inspection of any remaining contents in the containers and the remaining contents in the containers was weighed. The resulting data and findings were:

| | LOOSE | TAPPED | | REMAINING |
|---|---|---|---|---|
| | DENSITY | DENSITY | HAUSNER | WEIGHT IN CUP |
| SAMPLE | GR/CC | GR/CC | RATIO | AFTER BREWING |
| Original | 0.508 | 0.579 | 1.14 | 9.6 grams of thick |
| Agglomerates | | | | wetted cocoa mix |
| Agglomerates −30 + 40 | 0.530 | 0.583 | 1.100 | 1.5 grams of very |
| U.S. Mesh | | | | slightly cloudy |
| | | | | brownish water |
| Agglomerates −30 + 50 | 0.503 | 0.555 | 1.103 | 4.6 grams of |
| U.S. Mesh | | | | slightly cloudy |
| | | | | brownish water |
| Agglomerates −30 + 100 | 0.476 | 0.544 | 1.141 | 8.1 grams of thick |
| U.S. Mesh | | | | wetted cocoa mix |

These results show that successful brewing results (i.e. no significant mass of cocoa left behind in portion-package after brewing) require agglomeration and/or sizing to a specific particulate size range. In this example, particulates ranging from −30 mesh to +50 mesh provide successful brewing results. This example also shows that the combined effect of agglomeration and sizing to a specific particulate size range results in lowering the Hausner Ratio, and that the lower Hausner Ratios brew successfully. Because brewing in a brewer has a water-inflow action which works to fluidize the powder, and the Hausner Ratio is indicative of the ease of fluidization of the powder, the successful brewing results of the agglomerated and sized hot cocoa mix are reflected in the relative values of the Hausner Ratio as compared to the Hausner Ratios for unsuccessful brewing agglomerates.

### Example 3

Un-agglomerated hot cocoa mix of a different production lot but of the same ingredients and formula as in Examples 1 was agglomerated using the same equipment and fluid application amounts and rates as in Example 2. A moisture of 1.71% resulted in the unscreened agglomerated particulates from this first run. The agglomerated mix was then sized using a Sweco gyratory screener using a U.S. 30 mesh screen (597 microns) to remove over-sized agglomerates and a U.S. 60 mesh screen (250 micron opening) to remove under-sized particulates. 17.9 weight % undersized agglomerates were removed. These under-sized agglomerated particulates were then added to enough unagglomerated cocoa powder (as fines recycle) to total 5 kilograms. This mix was then agglomerated in a second run and sized using identical conditions and procedures as the initial agglomeration. A moisture of 1.91% resulted from this second agglomeration run. 13.6 weight %-60 mesh under-sized fines were removed as a result of the sizing screening. Triplicate samples of the second run −30/+60 mesh agglomerated particulates were prepared by placing approximately 15 grams of the −30 mesh/+60 mesh agglomerated particulates into beverage cartridges, then tapped 100 times as was done in Examples 1 and 2, and then each brewed in a Keurig brewing appliance (same as Example 1 and Example 2) with 8 ounces (227 milliliters) of a hot water flow stream (at approximately 90 degrees Celsius) over about a 30 second brewing period at a constant flow rate. The triplicate sample cartridges were then opened by peeling-off the aluminum cover. The contents of the cartridges were weighed and found to be 6.2 grams, 5.5 grams, and 10.0 grams, respectively, of thick viscous wet cocoa mass, indicating failed, e.g. unsuccessful brewing results. This result relative to Example 2 shows that the particulate size range of the sized agglomerated particulates is surprisingly narrow in that −30 mesh/+60 mesh was unsuccessful in brewing whereas the −30 mesh/+50 mesh agglomerates of Experiment 2 were successful.

To confirm the relative brewing results of Examples 2 and 3, the −30 mesh/+60 mesh sized agglomerates of Example 3 was re-sized using a U.S. 50 mesh screen (a 297 micron opening), and then packaged and brewed. Duplicate samples were prepared and then tapped 100 times using the above described methods. The brewed cartridges of the duplicate samples were opened and found to be virtually free of any cocoa mix, e.g. only slightly cloudy slightly brownish water remained in the package. The results confirmed that screening a −30/+50 mesh provide successful brewing results, indicating that a specific particulate size range of agglomerates is required.

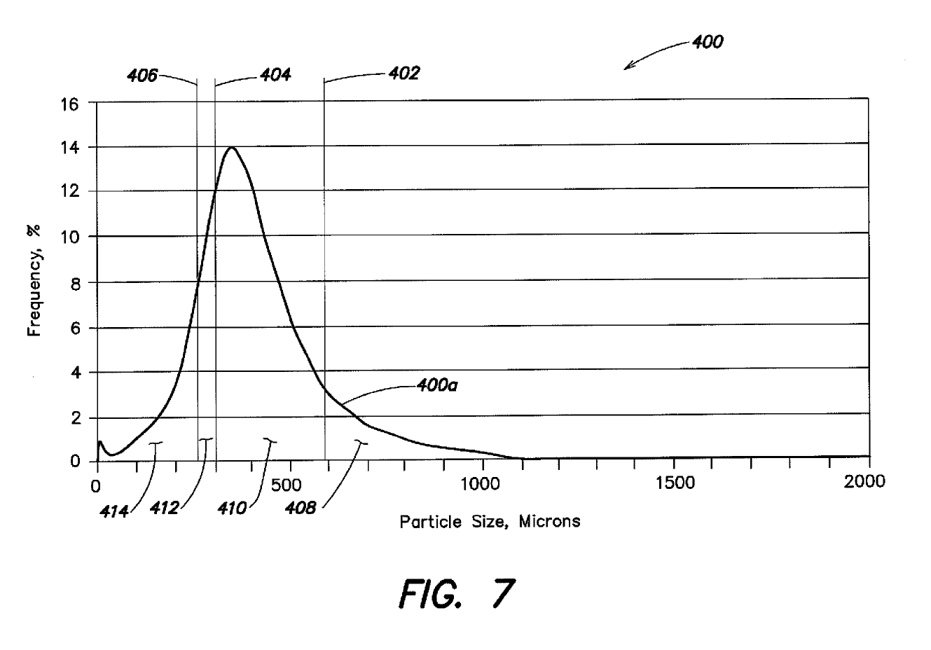

These Example 3 results are depicted and further illuminated on a particulate size distribution plot illustrated in FIG. 7. The size distribution plot 400 of resulting agglomerated particulates are from the second run of hot cocoa prior to sizing through the 60 mesh screen and re-sizing on a 50 mesh screen. The distribution curve is 400a which plots the frequency % of numbers of particulates against the particulate size in microns. Line 402 is at the 595 micron mark which is the opening size for a U.S. 30 mesh screen. Line 404 is at the 297 micron mark which is the opening size for a U.S. 50 mesh screen, and Line 406 is for a U.S. 60 mesh screen. Assuming the agglomerated particulates are not further reduced in size during the screening process, all the agglomerated particulates to the right of line 402 are removed as over-sized by the 30 mesh screen. All to the left of line 404 are removed as under-sized by the 50 mesh screen. All to the left of line 406 would be removed by the 60 mesh screen. Thus, for successful brewing results using one embodiment of the present innovations, agglomerated particulates in area 408 are removed as over-sized, agglomerated particulates in areas 412 and 414 are removed as under-sized, and area 410 represents the desired group of particulates for forming a beverage precursor.

### Example 4

The present state of the art of powder flow enhancement teaches generally that powder flow aids can be added to improve the flowability of powders (and thus most likely, the ease of fluidization of settled and non-settled powders by hot water.) See Onwulata, Konstance, and Holsinger journal article mentioned above at Table 1 where specifically, the Hausner ratio is improved (lowered) by adding flow aids (the implication being an overall improvement of powder flowability).

To investigate whether added flow aids could make the unsuccessful-brewing −30 mesh/+60 mesh agglomerated particulates brew successfully, two different silicon dioxide flow aids were obtained from Evonik Degussa Corporation, 3500 Embassy Parkway, Akron, Ohio USA 44333. These were Sipernat 22s and Sipernat 820a. 30/+50 mesh agglomerated particulates from Experiment 3 were mixed with 0.2 weight % of Sipernat 820a and also with 0.8 weight % of Sipernat 22s. Triplicate samples were prepared, tapped, brewed, and inspected according to the procedures employed in Example 3. For the Sipernat 820a triplicate samples, the portion-packages contained 5.5, 4.7, and 6.7 grams of wet cocoa mass, indicating unsuccessful brewing results. For the Sipernat 22s triplicate samples, the cartridges contained 8.4, 7.5, and 7.2 grams of wet cocoa mass, also indicating unsuccessful brewing results. In some of these brewed cartridges, the interior of the wet cocoa mass was found to contain dry powder. Thus, recommendations from the present state of the art to use flow aids to improve brewing results of improperly-size-selected agglomerated particulates do not provide successful results, with an indication that including such flow aids can aggravate the brewing results, making them worse, not better.

### Example 5

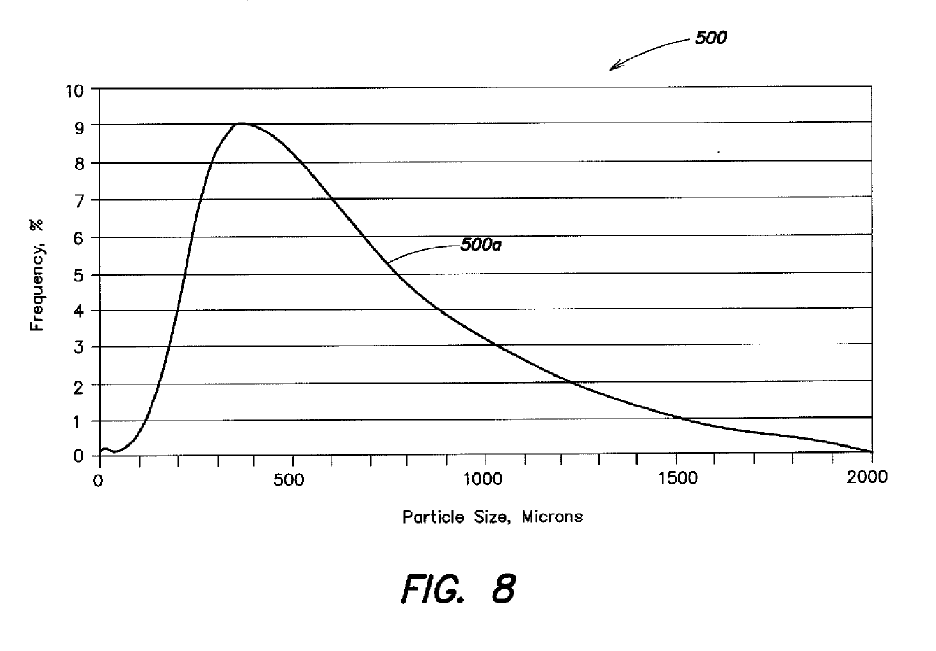

Approximately 9 pounds of a mixture of Chai tea beverage precursor materials (including tea, spices, sucralose sweetener, and non-dairy creamer) was agglomerated using the equipment and procedures used in the prior examples. The amount of gum arabic applied was 165 gram in a 20% aqueous solution. The amount of soy lecithin applied was 20.5 grams in a 20% aqueous dispersion-solution. A moisture of 1.25% resulted. A size frequency distribution plot 500 of the agglomerated particulates but unsized Chai tea is shown in FIG. 8 as distribution curve 500a. The agglomerated particulates were screened through a U.S. 30 mesh and a U.S. 50 mesh as in previous examples to remove the over-size and under-sized agglomerated particulates. These sized agglomerated particulates were dosed into a beverage cartridge and tapped 100 times. Quadruplicate samples were prepared. Each sample was brewed according to preferred embodiments of the present innovations, each using a different model of the Keurig, Incorporated brewer appliance range. These were the B70, the B75, the B200, and the B2003 models. Each sample was opened and inspected after brewing. All samples were found to have brewed successfully, with less than one gram of wet Chai tea agglomerates remaining in each package after brewing.

It should be appreciated that various embodiments of the present invention may be formed with one or more of the above-described features. The above aspects and features of the invention may be employed in any suitable combination as the present invention is not limited in this respect. It should also be appreciated that the drawings illustrate various components and features which may be incorporated into various embodiments of the present invention. For simplification, some of the drawings may illustrate more than one optional feature or component. However, the present invention is not limited to the specific embodiments disclosed in the drawings. It should be recognized that the present invention encompasses embodiments which may include only a portion of the components illustrated in any one drawing figure, and/or may also encompass embodiments combining components illustrated in multiple different drawing figures.

It should be understood that the foregoing description of various embodiments of the invention are intended merely to be illustrative thereof and that other embodiments, modifications, and equivalents of the invention are within the scope of the invention recited in the claims appended hereto.

What is claimed is:

1. A beverage cartridge for use with a beverage forming machine, comprising:
a container that defines an internal volume and is water tight, the container being arranged to permit liquid to be introduced by a beverage forming machine into the container at a volumetric flow rate of at least 0.03 ounces/second and to permit a beverage to exit the container; and
a substantially soluble beverage precursor disposed within the container, wherein the substantially soluble beverage precursor is formed of a plurality of particulates wherein at least 60% of the plurality of particulates have a largest dimension that is greater than about 200 microns and less than about 700 microns, the beverage precursor having a volume;
wherein the internal volume of the container is greater than the volume of the beverage precursor and is arranged such that liquid introduced into the container dissolves the beverage precursor to form a beverage.

2. The beverage cartridge recited in claim 1, wherein the substantially soluble beverage precursor is an agglomerated mixture.

3. The beverage cartridge recited in claim 1, wherein at least 80% of the plurality of particulates have a largest dimension that is greater than about 200 microns and less than about 700 microns.

4. The beverage cartridge recited in claim 1, wherein at least 90% of the plurality of particulates have a largest dimension that is greater than about 300 microns and less than about 600 microns.

5. The beverage cartridge recited in claim 1, wherein at least 95% of the plurality of particulates have a largest dimension that is greater than about 200 microns and less than about 700 microns.

6. The beverage cartridge recited in claim 1, wherein all of the plurality of particulates have a largest dimension that is less than about 700 microns.

7. The beverage cartridge recited in claim 1, wherein the beverage precursor is configured for a single serving of between about 4 ounces and 12 ounces.

8. The beverage cartridge recited in claim 1, wherein the beverage precursor includes at least one of cocoa, chocolate, tea, milk powder, non-dairy creamer, juice extract, espresso, coffee powder, sugar, lactose, sucrose, sucralose, flow aids, stevia, emulsifiers, monoglycerides, diglycerides, and lecithin.

9. The beverage cartridge recited in claim 1, wherein the cartridge is configured to receive a turbulent flow of liquid having a Reynolds Number of at least 4000.

10. The beverage cartridge recited in claim 1, wherein the container is arranged to be piercable to define an inlet for liquid introduced into the container, and arranged to be piercable to define an outlet for the beverage to exit the container.

11. The beverage cartridge recited in claim 1, wherein the beverage cartridge does not include a filter positioned downstream of the beverage precursor.

12. The beverage cartridge recited in claim 1, wherein the container includes a substantially flat bottom, a frustoconical sidewall extending upwardly from the bottom, a rim extending from an upper end of the sidewall and defining an opening that allows access to the internal volume, and a cover attached to the rim of the container and closing the opening.

13. A beverage cartridge comprising:
a container including a substantially flat bottom, a frustoconical sidewall extending upwardly from the bottom, a rim extending from an upper end of the sidewall and defining an opening that allows access to a fixed internal volume of the container, and a cover attached to the rim of the container and closing the opening such that the container defines a water tight structure, the container being arranged to permit liquid to be introduced by a beverage forming machine into the container at a volumetric flow rate of at least 0.03 ounces/second and to permit a beverage to exit the container;
a substantially soluble beverage precursor disposed within the container, wherein the substantially soluble beverage precursor is formed of a plurality of particulates wherein at least 60% of the plurality of particulates have a largest dimension that is greater than about 300 microns and less than about 600 microns, the beverage precursor having a volume;
wherein the internal volume of the container is greater than the volume of the beverage precursor and is arranged such that liquid introduced into the container dissolves the beverage precursor to form a beverage.

14. A method of preparing a beverage, comprising the steps of:
(a) providing a water tight beverage cartridge having a container with an internal volume, and a substantially soluble beverage precursor disposed within the container, wherein the substantially soluble beverage precursor is formed of a plurality of particulates wherein at least 60% of the plurality of particulates have a largest dimension that is greater than about 200 microns and less than about 700 microns;
(b) providing a first opening in the container;
(c) introducing a liquid into the beverage cartridge through the first opening at a volumetric flow rate of at least 0.03 ounces/second, thereby forming a beverage when the beverage precursor dissolves in the liquid; and
(d) providing a second opening in the container, such that the beverage exits the second opening.

15. The method recited in claim 14, wherein a turbulent flow of the liquid is introduced into the beverage cartridge having a Reynolds Number of at least 4000.

16. The method recited in claim 14, wherein a size of the first opening is greater than a size of the second opening.

17. The method recited in claim 14, wherein the plurality of particles are an agglomerated mixture.

18. The method recited in claim 14, wherein the first opening is formed by piercing a hole through the cartridge.

19. The method recited in claim 14, wherein the beverage precursor includes at least one of cocoa, chocolate, tea, milk powder, non-dairy creamer, juice extract, espresso, coffee powder, sugar, lactose, sucrose, sucralose, flow aids, emulsifiers, monoglycerides, diglycerides, and lecithin.

20. The method recited in claim 14, wherein the container includes a frustoconic shape with a substantially flat bottom, a sidewall and a rim defining an opening that provides access to the internal volume, and a cover closes the opening.

21. A beverage system comprising:
a container having an internal volume and is water tight, the container being arranged to permit liquid to be introduced into the container at a volumetric flow rate of at least 0.03 ounces/second and to permit a beverage to exit the container;
a substantially soluble beverage precursor disposed within the container, wherein the substantially soluble beverage precursor is formed of a plurality of particulates wherein at least 60% of the plurality of particulates have a largest dimension that is greater than about 200 microns and less than about 700 microns, the beverage precursor having a volume;
an inlet configured to provide liquid into the container through a first opening to form a beverage when the beverage precursor dissolves in the liquid; and
an outlet configured to dispense the beverage from the container.

22. The beverage system recited in claim 21, wherein the internal volume of the container is greater than the volume of the beverage precursor, such that the liquid can be introduced into the container to dissolve the beverage precursor to form a beverage within the container.

23. The beverage system recited in claim 21, wherein the substantially soluble beverage precursor is an agglomerated mixture.

24. The beverage system recited in claim 21, wherein the beverage precursor includes at least one of cocoa, chocolate, tea, milk powder, non-dairy creamer, juice extract, espresso, coffee powder, sugar, lactose, sucrose, sucralose, flow aids, stevia, emulsifiers, monoglycerides, diglycerides, and lecithin.

25. The beverage system recited in claim 21, wherein the inlet includes a piercing element that forms an inlet opening in the container, and the outlet includes a piercing element that forms an outlet opening in the container.

26. The beverage system recited in claim 21, wherein the beverage cartridge does not include a filter positioned downstream of the beverage precursor.
